(19) United States
(12) Patent Application Publication
(10) Pub. No.: US 2021/0396353 A1
(43) Pub. Date: Dec. 23, 2021

(54) SYSTEM FOR MANAGING PRESSURE IN UNDERGROUND CRYOGENIC LIQUID STORAGE TANK AND METHOD FOR THE SAME

(71) Applicants: China Energy Investment Corporation Limited, Beijing (CN); National Institute of Clean-and-Low-Carbon Energy, Beijing (CN)

(72) Inventors: Xianming Li, Orefield, PA (US); Pingjiao Hao, Fremont, CA (US); Edward Youn, Pacific Grove, CA (US); Anthony Ku, Fremont, CA (US); Jerad Allen Stager, Richmond, CA (US); Noam Hart, Stanford, CA (US); Ashish Alvin Prakash, Hayward, CA (US)

(21) Appl. No.: 16/904,548

(22) Filed: Jun. 17, 2020

(51) Int. Cl. F17C 1/00; F17C 13/02; F17C 5/02

(52) U.S. Cl. CPC F17C 1/007; F17C 2205/0341; F17C 5/02; F17C 2225/0161; F17C 2227/0135; F17C 2205/0332; F17C 2205/035; F17C 2227/0388; F17C 2250/043; F17C 2221/012; F17C 2221/011; F17C 2221/014; F17C 2221/016; F17C 2221/033; F17C 2221/035; F17C 13/025

(57) ABSTRACT

The present disclosure provides a system for managing a pressure in an underground cryogenic liquid storage tank and a method for the same. The system includes: a storage tank, which is used for containing cryogenic liquid and is buried underground; an internal pump, which is located below a liquid level of the cryogenic liquid; an evaporator, provided with an upstream end which is in communication with a discharge end of the internal pump and a downstream end which is in communication with a head space via a vapor delivery line; a control valve, which is disposed on the vapor delivery line downstream of the evaporator; and a flow limiter, which is disposed on the vapor delivery line upstream of or downstream of the control valve. The present disclosure can realize efficient pressurization to the storage tank so as to prevent collapsing of the storage tank.

### FIELD OF THE INVENTION

The present disclosure relates to managing a pressure in cryogenic liquid storage tank, and in particular, to a system for managing a pressure in an underground cryogenic liquid storage tank and a method for the same.

### BACKGROUND OF THE INVENTION

Pressure building for a cryogenic tank is a key method to manage tank pressure. Maintaining tank pressure close to the atmospheric level keeps the liquid temperature near its normal boiling point, while allowing tank pressure to become sub-atmospheric level (vacuum) can collapse the inner vessel.

U.S. Pat. No. 5,937,655 discloses a device for pressurizing a tank containing a supply of cryogenic liquid, and the device has a tubular enclosure disposed within the cryogenic liquid. The tubular enclosure has an opening in its bottom and is in communication with a pressure builder coil external to the tank. A vapor side of the pressure builder coil is in communication with a head space of the tank. An electric heater element is disposed in the bottom of the tubular enclosure. An insulating tube is optionally disposed about the tubular enclosure. In addition, a ball is optionally positioned adjacent the opening in the tubular enclosure so that a check valve is formed. The device may fit through tops of existing cryogenic storage tanks. However, in this patent, an external tube or an external heat exchanger is included, and the pressure builder coil of a conventional gravity flow is used. Therefore, the cryogenic liquid storage tank is not suitable for being buried underground directly.

U.S. Pat. No. 6,805,173 B2 discloses a pressure control method and a pressure control system for controlling a pressure in an ullage vapor space of a volatile liquid fuel underground storage tank (“UST”). When the pressure in the ullage vapor space is increased, vapor is allowed to flow into an auxiliary device which has a vapor space of variable volume defined at least in part by a resilient wall member, so that a volume of vapor that may be released to the environment is reduced. However, in this patent, the method for increasing the pressure in the storage tank involves the removal of liquid fuel and an extension of external tube. Therefore, this patent is not applicable to a fuel tank to be buried directly.

Further, U.S. Patent US 2014/0096539 A1 discloses a cryogenic fluid delivery system which includes a tank configured to contain a supply of cryogenic liquid, with the tank including a head space configured to contain a vapor above the cryogenic liquid stored in the tank. A liquid withdrawal line is configured to communicate with the cryogenic liquid stored in the tank. A vaporizer has an inlet that is in communication with the liquid withdrawal line and an outlet that is in communication with a vapor delivery line. A pressure building circuit is in communication with the vapor delivery line and the head space of the tank. The pressure building circuit includes a flow inducing device and a control system for activating the flow inducing device when a pressure within the head space of the tank drops below a predetermined minimum pressure and/or when other conditions exist. This patent discloses a method for building a pressure by utilizing gravity so as to increase pressure head of vapor in the cryogenic tank, and an external tube is required. Therefore, this patent is applicable only for a circumstance where a tank is disposed above ground.

In view of the foregoing, the inventor of the present disclosure provides a system for managing a pressure in an underground cryogenic liquid storage tank and a method for the same.

### SUMMARY OF THE INVENTION

The present disclosure aims to provide a system for managing a pressure in an underground cryogenic liquid storage tank and a method for the same, so as to solve a problem that an existing storage tank is not suitable for being buried underground.

In order to achieve the above objective, the present disclosure provides a system for managing a pressure in an underground cryogenic liquid storage tank, which includes:

a storage tank, which is used for containing cryogenic liquid, has a head space for containing vapor above the cryogenic liquid therein, and is buried underground;

an internal pump, which is located in the storage tank, wherein an inlet of the internal pump is located below a liquid level of the cryogenic liquid;

an evaporator, provided with an upstream end which is in communication with a discharge end of the internal pump via a liquid discharge line and a downstream end which is in communication with the head space via a vapor delivery line;

a control valve, which is disposed on the vapor delivery line downstream of the evaporator; and

a flow limiter, which is disposed on the vapor delivery line upstream of or downstream of the control valve.

In a preferred embodiment, the system further includes: a heat exchanger, which is disposed on a line upstream of the evaporator and a line downstream of the control valve at the same time.

In a preferred embodiment, the system further includes: a heat exchanger, which is disposed on a line parallel to the evaporator and a line downstream of the control valve at the same time.

In a preferred embodiment, the system further includes: a heat exchanger, which is disposed on a line downstream of the control valve.

In a preferred embodiment, the heat exchanger is a recuperative heat exchanger.

In a preferred embodiment, the heat exchanger is replaced with coolant, a cooler, cold water or a para-ortho reactor.

In a preferred embodiment, the head space is further in communication with a pressure sensor for sensing a pressure in the head space.

In a preferred embodiment, the head space is further in communication with a pressure relief valve for reducing the pressure in the head space.

In a preferred embodiment, the cryogenic liquid includes, but is not limited to, hydrogen, natural gas, oxygen, nitrogen, propane or argon.

In a preferred embodiment, the internal pump is an immersed pump or a self-priming pump.

In a preferred embodiment, the control valve is an automatic valve.

In a preferred embodiment, a filter is disposed on the liquid discharge line and/or the vapor delivery line.

The present disclosure further discloses a method for managing a pressure in an underground cryogenic liquid storage tank. The method includes the following steps of:

(1) injecting cryogenic liquid into a storage tank buried underground, placing an internal pump in the storage tank with an inlet of the internal pump located below a liquid level of the cryogenic liquid, and keeping a head space above the cryogenic liquid in the storage tank;

(2) communicating an upstream end of an evaporator with a discharge end of the internal pump via a liquid discharge line, and communicating a downstream end of the evaporator with the head space via a vapor delivery line;

(3) disposing a control valve on the vapor delivery line downstream of the evaporator;

(4) disposing a flow limiter on the vapor delivery line upstream of or downstream of the control valve; and

(5) evaporating, by the evaporator, the cryogenic liquid, which flows out through the liquid discharge line under suction effect of the internal pump when a pressure in the head space is too low, into warm vapor, and delivering the warm vapor to the head space through the vapor delivery line, so as to pressurize the storage tank until a target storage tank pressure is reached.

In a preferred embodiment, a heat exchanger is disposed on a line upstream of the evaporator and a line downstream of the control valve at the same time between step (4) and step (5).

In a preferred embodiment, a heat exchanger is disposed on a line parallel to the evaporator and a line downstream of the control valve at the same time between step (4) and step (5).

In a preferred embodiment, a heat exchanger is disposed on a line downstream of the control valve between step (4) and step (5).

In a preferred embodiment, the heat exchanger is a recuperative heat exchanger.

In a preferred embodiment, the heat exchanger is replaced with coolant, a cooler, cold water or a para-ortho reactor.

In a preferred embodiment, the head space is further in communication with a pressure sensor for sensing the pressure in the head space.

In a preferred embodiment, the head space is further in communication with a pressure relief valve for reducing the pressure in the head space.

In a preferred embodiment, the cryogenic liquid includes, but is not limited to, hydrogen, natural gas, oxygen, nitrogen, propane or argon.

In a preferred embodiment, the internal pump is an immersed pump.

In a preferred embodiment, the control valve is an automatic valve.

In a preferred embodiment, a filter is disposed on the liquid discharge line and/or the vapor delivery line.

The present disclosure has the following beneficial effects. By using proper devices such as an internal pump, a flow limiter and an automatic valve, the storage tank can be pressurized efficiently so as to prevent collapsing of the storage tank. Since the storage tank does not include any external pressurization device or a liquid discharge line extending downward, the storage tank can be buried underground directly without any shelter, which reduces the footprint for equipment. The immersed pump is kept cool without thermal cycling, thus extending equipment life, allowing quick startup and eliminating liquid boil-off otherwise associated with pump cooldown.

### BRIEF DESCRIPTION OF THE DRAWINGS

FIG. 1 schematically shows a first embodiment according to the present disclosure;

FIG. 2 schematically shows a second embodiment according to the present disclosure;

FIG. 3 schematically shows a third embodiment according to the present disclosure;

FIG. 4 schematically shows a fourth embodiment according to the present disclosure; and

FIG. 5 schematically shows a comparative example.

### DETAILED DESCRIPTION OF THE EMBODIMENTS

The present disclosure will be described in detail with reference to the accompanying drawings.

### First Embodiment

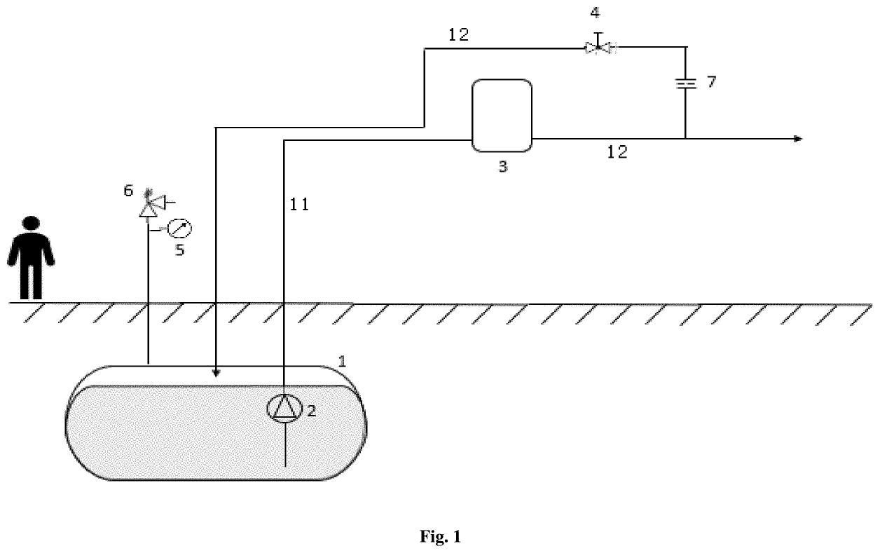

As shown in FIG. 1, the first embodiment discloses a system for managing a pressure in an underground cryogenic liquid storage tank, which includes: a storage tank 1, an internal pump 2, an evaporator 3, a control valve 4, a pressure sensor 5, a pressure relief valve 6, a flow limiter 7, a liquid discharge line 11 and a vapor delivery line 12. The storage tank 1 is used for containing cryogenic liquid, and has a head space above the cryogenic liquid therein. The head space is configured for containing vapor.

The storage tank 1 is provided with the internal pump 2 therein. The internal pump 2 is preferably an immersed pump, and is located below a liquid level of the cryogenic liquid. Alternatively, the internal pump 2 may also be a self-priming pump, an inlet of which is located below the liquid level of the cryogenic liquid. The internal pump 2 of the present disclosure is not limited to the immersed pump or the self-priming pump, and may be other types of pumps that are suitable for being mounted inside the storage tank 1 and are used for pumping the cryogenic liquid. The liquid discharge line 11 connected to the internal pump 2 extends upward through the storage tank 1 and is in communication with an upstream end of the evaporator 3. The head space of the storage tank 1 is in communication with the vapor delivery line 12, and a downstream end of the evaporator 3 is in communication with the vapor delivery line 12. The control valve 4 is preferably an automatic valve, which is disposed on the vapor delivery line 12 and is located between the evaporator 3 and the head space. When a pressure within the head space drops below a predetermined minimum pressure and/or when other conditions exist, the cryogenic liquid is discharged through the liquid discharge line 11 under suction effect of the internal pump 2 and is evaporated by the evaporator 3 into warm vapor (in a gaseous state or in a super-critical state), and the warm vapor is delivered to the head space through the vapor delivery line 12 so as to pressurize the storage tank 1.

Preferably, the vapor delivery line 12 upstream of or downstream of the control valve 4 may further be provided with the flow limiter 7 thereon (the flow limiter 7 is located upstream of the control valve 4 in FIG. 1), which is used for restricting an amount of high-pressure warm vapor flowing through the line, so as to avoid unnecessary damage due to very quick pressurization to the storage tank 1. Preferably, the flow limiter 7 may be a restriction orifice. When the pressure in the storage tank 1 is too low, the control valve 4 will open automatically. When a flow gradually increases, the pressure in the storage tank 1 increases. When a pressure difference between an upstream end of the flow limiter 7 and a downstream end of the flow limiter 7 exceeds a certain numerical value (which is called the critical pressure differential), no matter how the pressure difference increases, as long as the pressure at the upstream end of the flow limiter 7 remains constant, an amount of flow passing through the flow limiter 7 will maintain at a certain numerical value and will no longer increase. Accordingly, the flow limiter 7 may control the vapor entering the storage tank 1 at a level that does not exceed a level for a safe relief capability of the storage tank. When the amount of the flow, which passes through the flow limiter 7, stops increasing, a maximum amount of the flow corresponds to a maximum pump discharge pressure. Under a lower pump discharge pressure, the amount of the flow will reduce linearly because of a lower density.

In addition, the head space is further in communication with the pressure sensor 5 and the pressure relief valve 6. The pressure sensor 5 is used for sensing the pressure in the head space. When the pressure exceeds a set threshold, the pressure relief valve 6 is opened to reduce the pressure in the head space, so as to effectively protect the storage tank 1.

The cryogenic liquid may be hydrogen, natural gas, oxygen, nitrogen, propane, argon or other cryogenic liquids.

Preferably, the line may be further provided with a filter thereon (not shown in Figures) for filtering impurities in the line.

The warm vapor discharged from the evaporator 3 enables the storage tank 1 to have a certain pressure rise rate. The pressure rise rate depends on the liquid level, and the combined action of mass addition and sensible heat of the warm vapor causes the pressure in the storage tank to increase. Taking hydrogen gas as an example, the sensible heat difference of the hydrogen gas from the ambient temperature to the liquid hydrogen temperature is approximately 10 times the latent heat of evaporation. Therefore, such sensible heat may have a significant effect. If all the sensible heat is used for evaporating the liquid, the pressure in the tank will rise at a maximum rate. The reality is somewhere in between where only a part of the sensible heat directly causes vaporization, which may be determined through experiments. Pressure rise process requires a certain time and does not occur instantaneously, which can ensure safety.

For a liquid hydrogen storage tank of 1500 gallon (5.7 m³) having a pressure relief capability of 494 scfm (13.2 Nm³/min), under 25° C. and 45 MPa (pump discharge pressure), enough hot hydrogen gas may pass through one flow limiter 7 which has orifice size of 1 mm. If the liquid hydrogen in the storage tank is at 95% and that all sensible heat of the warm hydrogen gas is assumed to be used for evaporating the liquid hydrogen, the pressure in the storage tank would increase at a rate of 123 psi/s. This circumstance represents the most effective solution. If no sensible heat is available for evaporating the liquid, the pressure will rise at a rate of 13.2 psi/s. In reality, the pressure rises at a rate between the two rates, thus the two rates represent the upper limit and the lower limit under the given conditions. When there is less liquid in the storage tank, there is more gas space for the vapor to fill in. Accordingly, the pressure rise rate reduces. The same is true for reduction of the pump discharge pressure. Under 5 MPa and a liquid level of 15%, for the circumstance that 100% of the sensible heat is used for evaporation and the circumstance that 0% of the sensible heat is used for evaporation, the pressure rise rates are respectively changed to 0.73 psi/s and 0.083 psi/s. Likewise, the liquid level and the pump discharge pressure determines a working range. Similar evaluation may be performed for different sizes of restriction orifice. Results are summarized in the following Table 1.

TABLE 1

| | | Orifice size | Orifice size |
|---|---|---|---|
| | Unit | of 1 mm | of 0.5 mm |
| Maximum pressure rise conditions | | | |
| Pump discharge pressure | MPa | 45 | 45 |
| Highest liquid level in the | | 95% | 95% |
| storage tank | | | |
| Pressure rise rate, 100% of | psi/s | 123 | 31 |
| the sensible heat being used | | | |
| for evaporation | | | |
| Pressure rise rate, 0% of the | psi/s | 13.2 | 3.3 |
| sensible heat being used for | | | |
| evaporation | | | |
| Minimum pressure conditions | | | |
| Pump discharge pressure | MPa | 5 | 5 |
| Lowest liquid level in the | | 15% | 15% |
| storage tank | | | |
| Pressure rise rate, 100% of | psi/s | 0.73 | 0.18 |
| the sensible heat being used | | | |
| for evaporation | | | |
| Pressure rise rate, 0% of the | psi/s | 0.083 | 0.021 |
| sensible heat being used for | | | |
| evaporation | | | |

As can be seen, by using proper devices such as the internal pump, the restriction orifice and the automatic valve, the storage tank can be pressurized efficiently. Since the storage tank 1 in the first embodiment does not include any external pressurization device or a liquid discharge line extending downward, the storage tank can be buried underground directly without any shelter. Further, the arrangement in the first embodiment can prevent collapsing of an internal container and maximizes volumetric efficiency of the pump inside the underground storage tank, without an external tube or a heat exchange surface. With the storage tank suitable for being buried underground in the present embodiment, it is allowed to build a hydrogen refueling station in urban areas where land is scarce and expensive so as to better use land resources.

Most of cryogenic pumps on the market at present are disposed outside the storage tank. If the cryogenic pump is not used continuously like the way used in the hydrogen refueling station, the cryogenic pump is required to be cooled and restarted. However, a cooling process causes evaporation of a great amount of liquid, and cooling and heating cycles will damage sealing elements and shorten the service life of the device. The internal pump 2 in the first embodiment is immersed in the liquid, and thus is always kept at a low temperature and can be started immediately. Moreover, since the internal pump is always in a cryogenic environment, there is no thermal cycle which greatly improves the service life of the device.

### Second Embodiment

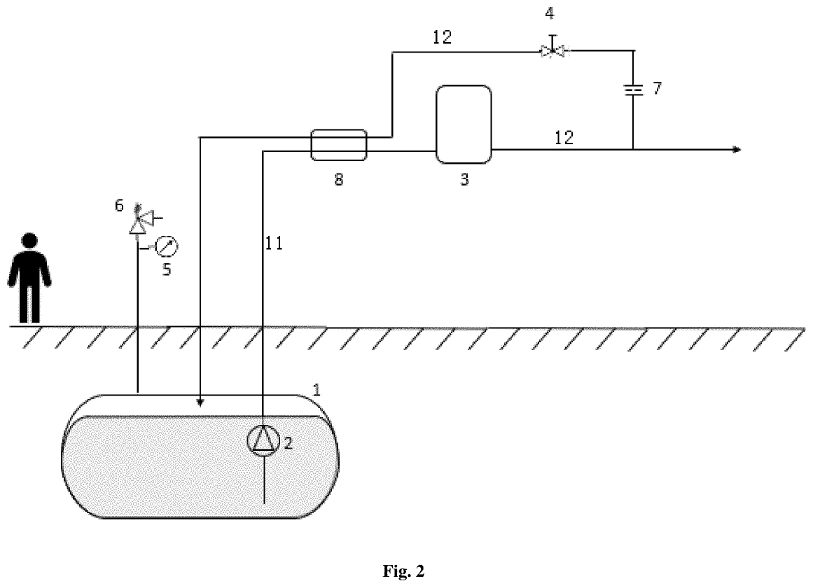

As shown in FIG. 2, the second embodiment discloses a system for managing a pressure in an underground cryogenic liquid storage tank. The main difference of the system in the second embodiment from the system in the first embodiment is that a heat exchanger 8, preferably a recuperative heat exchanger, is disposed on a line upstream of the evaporator 3 and on a line downstream of the control valve 4 at the same time.

The heat exchanger 8 may use cold high-pressure discharge therein or discharge of a portion of the cryogenic liquid pumped by the internal pump 2 upstream of the evaporator 3 to cool the warm vapor evaporated by the evaporator 3. By means of this manner, heat load in the storage tank 1 is reduced. Consequently, the pressure rise rate in the storage tank 1 is effectively controlled.

### Third Embodiment

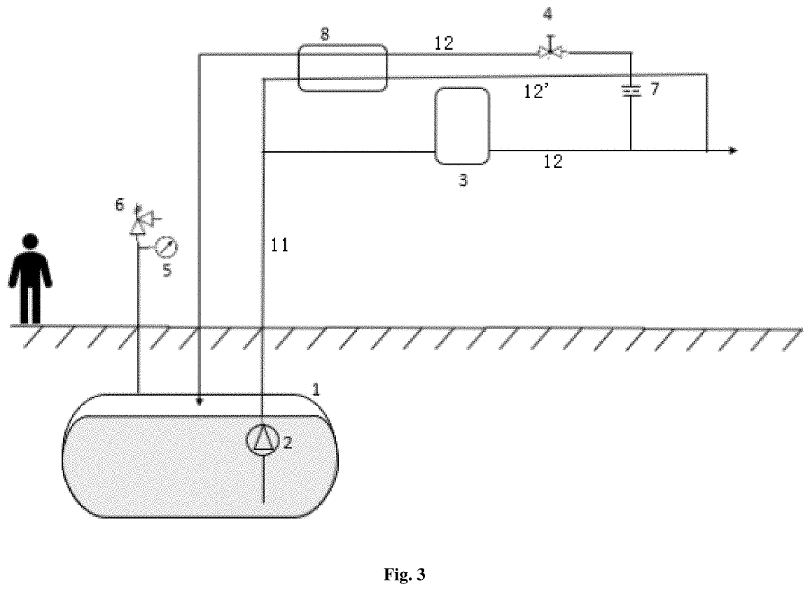

As shown in FIG. 3, the third embodiment discloses a system for managing a pressure in an underground cryogenic liquid storage tank. The main difference of the system in the third embodiment from the system in the second embodiment is that a heat exchanger 8, preferably a recuperative heat exchanger, is disposed on a line 12′ parallel to the evaporator 3 and on a line downstream of the control valve 4 at the same time.

The heat exchanger 8 may use discharge of a portion of the cryogenic liquid (for management of sensible heat) pumped by the internal pump 2 upstream of the evaporator 3 to cool the warm vapor evaporated by the evaporator 3, and this portion of discharge directly bypasses the evaporator 3.

By means of this manner, heat load in the storage tank 1 is reduced. Consequently, the pressure rise rate in the storage tank 1 is effectively controlled.

### Fourth Embodiment

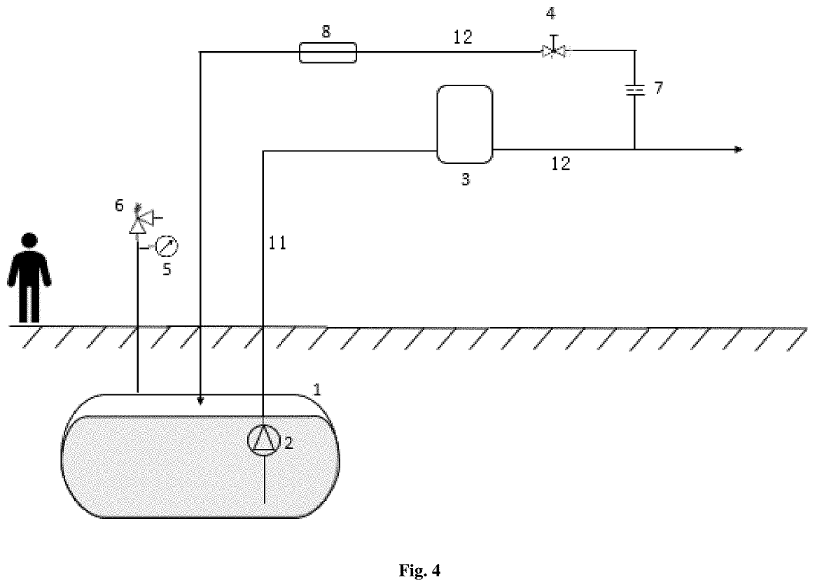

As shown in FIG. 4, the fourth embodiment discloses a system for managing a pressure in an underground cryogenic liquid storage tank. The main difference of the system in the fourth embodiment from the system in the first embodiment is that a heat exchanger 8, which may be replaced with coolant, a cooler, cold water or a para-ortho reactor, is disposed on a line downstream of the control valve 4.

The heat exchanger 8 (or the coolant, the cooler, the cold water or the para-ortho reactor) is used for cooling the warm vapor evaporated by the evaporator 3. By means of this manner, heat load in the storage tank 1 is reduced. Consequently, the pressure rise rate in the storage tank 1 is effectively controlled.

### Comparative Example

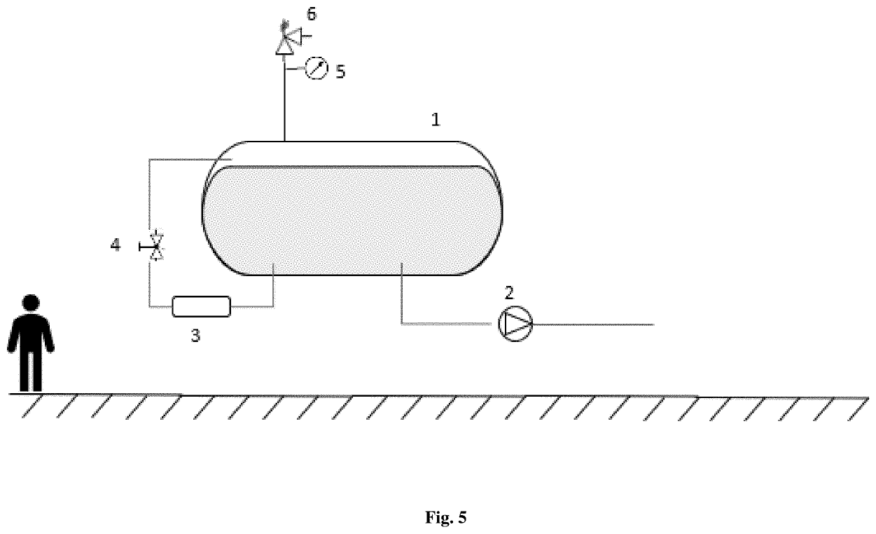

As shown in FIG. 5, the comparative example discloses an existing cryogenic liquid delivery system which includes a storage tank 1, an external pump 2, a pressure building evaporator 3 and a control valve 4 so as to build a pressure building circuit. In addition, the storage tank further includes devices such as a pressure sensor 5 and a pressure relief valve 6. The storage tank 1 is used for containing cryogenic liquid. The storage tank 1 has a head space above the cryogenic liquid therein, and the head space is configured to contain vapor above the cryogenic liquid.

The bottom of the storage tank 1 is in communication with a liquid discharge line, the pressure building evaporator 3, the control valve 4 and a vapor delivery line sequentially, and is in communication with the head space of the storage tank 1. After flowing out through the liquid discharge line, the cryogenic liquid passes through the evaporator 3 and is evaporated into vapor, and the vapor is delivered to the head space through the vapor delivery line, so as to pressurize the storage tank 1.

Further, the head space is in communication with the pressure sensor 5 and the pressure relief valve 6. The pressure sensor 5 is used for sensing a pressure in the head space. When the pressure exceeds a set threshold, the pressure relief valve 6 is opened to reduce the pressure in the head space, so as to effectively protect the storage tank 1.

Since the pressure building circuit in the comparative example is disposed outside the storage tank 1, access is required for its maintenance. The liquid discharge line is disposed under the storage tank 1, and the cryogenic liquid is discharged by gravity. Accordingly, the storage tank in the comparative example is not suitable for being buried underground.

To sum up, the present disclosure has the following beneficial effects. By using proper devices such as an internal pump, the restriction orifice and the automatic valve, the storage tank can be pressurized efficiently so as to prevent collapsing of the storage tank. Since the storage tank does not include any external pressurization device or a liquid discharge line that depends on gravity, the storage tank can be buried underground directly without any shelter, reduces the footprint for equipment. The immersed pump is kept cool without thermal cycling, thus extending equipment life, allowing quick startup and eliminating liquid boil-off otherwise associated with pump cooldown.

Although the present disclosure has been described with reference to preferred embodiments, various modifications may be made to the embodiments, and components therein may be replaced with equivalents without departing from the scope of the present disclosure. In particular, as long as there is no structural conflict, respective technical features in respective embodiments may be combined in any manner. The present disclosure is not limited to the specific embodiments disclosed herein, but includes all technical solutions that fall within the scope of the claims.

1. A system for managing a pressure in an underground cryogenic liquid storage tank, wherein the system comprises:
a storage tank, which is used for containing cryogenic liquid, has a head space for containing vapor above the cryogenic liquid therein, and is buried underground;
an internal pump, which is located in the storage tank, wherein an inlet of the internal pump is located below a liquid level of the cryogenic liquid;
an evaporator, provided with an upstream end which is in communication with a discharge end of the internal pump via a liquid discharge line and a downstream end which is in communication with the head space via a vapor delivery line;
a control valve, which is disposed on the vapor delivery line downstream of the evaporator; and
a flow limiter, which is disposed on the vapor delivery line upstream of or downstream of the control valve.

2. The system for managing a pressure in an underground cryogenic liquid storage tank according to claim 1, wherein the system further comprises: a heat exchanger, which is disposed on a line upstream of the evaporator and a line downstream of the control valve.

3. The system for managing a pressure in an underground cryogenic liquid storage tank according to claim 1, wherein the system further comprises: a heat exchanger, which is disposed on a line parallel to the evaporator and a line downstream of the control valve.

4. The system for managing a pressure in an underground cryogenic liquid storage tank according to claim 1, wherein the system further comprises: a heat exchanger, which is disposed on a line downstream of the control valve.

5. The system for managing a pressure in an underground cryogenic liquid storage tank according to claim 2, wherein the heat exchanger is a recuperative heat exchanger, or the heat exchanger is replaced with coolant, a cooler, cold water or a para-ortho reactor.

6. The system for managing a pressure in an underground cryogenic liquid storage tank according to claim 3, wherein the heat exchanger is a recuperative heat exchanger or the heat exchanger is replaced with coolant, a cooler, cold water or a para-ortho reactor.

7. The system for managing a pressure in an underground cryogenic liquid storage tank according to claim 4, wherein the heat exchanger is a recuperative heat exchanger or the heat exchanger is replaced with coolant, a cooler, cold water or a para-ortho reactor.

8. The system for managing a pressure in an underground cryogenic liquid storage tank according to claim 1, wherein the head space is further in communication with a pressure sensor for sensing a pressure in the head space and a pressure relief valve for reducing the pressure in the head space.

9. The system for managing a pressure in an underground cryogenic liquid storage tank according to claim 1, wherein the cryogenic liquid comprises, but is not limited to, one of hydrogen, natural gas, oxygen, nitrogen, propane and argon.

10. The system for managing a pressure in an underground cryogenic liquid storage tank according to claim 1, wherein the internal pump is an immersed pump or a self-priming pump, and the control valve is an automatic valve.

11. The system for managing a pressure in an underground cryogenic liquid storage tank according to claim 1, wherein a filter is disposed on the liquid discharge line and/or the vapor delivery line.

12. A method for managing a pressure in an underground cryogenic liquid storage tank, wherein that the method comprises the following steps of:
(1) injecting cryogenic liquid into a storage tank buried underground, placing an internal pump in the storage tank with an inlet of the internal pump located below a liquid level of the cryogenic liquid, and keeping a head space above the cryogenic liquid in the storage tank;
(2) communicating an upstream end of an evaporator with a discharge end of the internal pump via a liquid discharge line, and communicating a downstream end of the evaporator with the head space via a vapor delivery line;
(3) disposing a control valve on the vapor delivery line downstream of the evaporator;
(4) disposing a flow limiter on the vapor delivery line upstream of or downstream of the control valve; and
(5) evaporating, by the evaporator, the cryogenic liquid, which flows out through the liquid discharge line under suction effect of the internal pump when a pressure in the head space is too low, into vapor, and delivering the vapor to the head space through the vapor delivery line, so as to pressurize the storage tank until a target storage tank pressure is reached.

13. The method for managing a pressure in an underground cryogenic liquid storage tank according to claim 12, wherein a heat exchanger is disposed on a line upstream of the evaporator and a line downstream of the control valve at the same time between step (4) and step (5).

14. The method for managing a pressure in an underground cryogenic liquid storage tank according to claim 12, wherein a heat exchanger is disposed on a line parallel to the evaporator and a line downstream of the control valve at the same time between step (4) and step (5).

15. The method for managing a pressure in an underground cryogenic liquid storage tank according to claim 12, wherein a heat exchanger is disposed on a line downstream of the control valve between step (4) and step (5).

16. The method for managing a pressure in an underground cryogenic liquid storage tank according to claim 13, wherein the heat exchanger is a recuperative heat exchanger or the heat exchanger is replaced with a coolant, a cooler, cold water or a para-ortho reactor.

17. The method for managing a pressure in an underground cryogenic liquid storage tank according to claim 14, wherein the heat exchanger is a recuperative heat exchanger or the heat exchanger is replaced with a coolant, a cooler, cold water or a para-ortho reactor.

18. The method for managing a pressure in an underground cryogenic liquid storage tank according to claim 15, wherein the heat exchanger is a recuperative heat exchanger or the heat exchanger is replaced with a coolant, a cooler, cold water or a para-ortho reactor.

19. The method for managing a pressure in an underground cryogenic liquid storage tank according to claim 12, wherein the head space is further in communication with a pressure sensor for sensing the pressure in the head space and a pressure relief valve for reducing the pressure in the head space.

20. The method for managing a pressure in an underground cryogenic liquid storage tank according to claim 12, wherein the cryogenic liquid comprises, but is not limited to, one of hydrogen, natural gas, oxygen, nitrogen, propane and argon.
